(19) United States
(12) Patent Application Publication
(10) Pub. No.: US 2019/0063719 A1
(43) Pub. Date: Feb. 28, 2019

(54) CERAMIC LAMPSHADE, LAMPSHADE SUPPORT, AND LAMP BASE

(71) Applicant: Vessel USA Inc., Escondido, CA (US)

(72) Inventor: Michael Stephenson, Escondido, CA (US)

(21) Appl. No.: 15/689,917

(22) Filed: Aug. 29, 2017

(51) Int. Cl. F21V 1/04; F21V 7/22; F21V 19/00

(52) U.S. Cl. CPC F21V 1/04; F21V 19/006; F21V 7/22

(57) ABSTRACT

A lamp includes: a base; a lampshade support coupled to the base, the lampshade support including: a hub; and a set of spokes extending radially outward from the hub; and a ceramic lampshade. A ceramic lamp includes: a ceramic base; and a ceramic lampshade that rests on a top surface of the ceramic base. A lamp includes: a ceramic cylindrical base with an open top and a set of through holes along a circumference of the ceramic cylindrical base; a light source coupled to the ceramic cylindrical base such that light is able to pass through the set of through holes and through the open top; and a ceramic lampshade having an open bottom and a top hole through which light is able to pass.

### BACKGROUND

Many consumers may want various lighting options for decorative reasons, safety concerns, and intended use of a space.

Existing lampshades are fragile, hard to clean or keep clean, and may withstand limited environmental conditions. Lampshade supports are not able to withstand significant loads and may limit the materials (and thicknesses thereof—thus limiting opacity) that may be used for a lampshade.

Furthermore, existing lampshades use materials that limit design options regarding size, shape, structural integrity, etc.

Therefore there exists a need for an opaque ceramic lampshade, shade support able to withstand the load of the ceramic lampshade, and ceramic lamp bases that provide alternative lighting options.

### SUMMARY

Some embodiments may provide an opaque lampshade. The lampshade may made of ceramic. The lampshade may have a cylindrical shape with open ends that allow light to pass out through the open ends.

A lampshade support for the lampshade is included in some embodiments. The lampshade support may include a hub and a set of spokes that extend radially outward from the hub. Each spoke may include multiple bends (e.g., two right angle bends) such that the lampshade may be supported and retained in position.

The lampshade support may further include a light source and/or associated hardware elements such as a light socket, spacer, washer, lock washer, nut, switch, cord, plug or connector, etc.

The lampshade support may have an associated base. The base may include a set of receptacles (e.g., through holes) that are each able to accept a portion of one of the spokes from the set of spokes. In this way, the lampshade support may be retained in position relative to the base (and thus the lampshade may be retained in position relative to the base and to the light source).

Some embodiments may provide a lamp that includes a base and lampshade. The base and lampshade may be made from ceramic. The base may include a set of through holes spanning a circumference of the base such that light is able to pass from a light source mounted to the pass through the set of through holes.

The lampshade may rest directly on a top surface of the base. The lampshade may include a through hole at the top and an open bottom such that light is able to pass through the open bottom and the through hole.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a front elevation view of a ceramic lampshade according to an exemplary embodiment;

FIG. 2 illustrates a top plan view of the ceramic lampshade of FIG. 1;

FIG. 3 illustrates an exploded front elevation view of a lampshade support according to an exemplary embodiment;

FIG. 4 illustrates a front elevation view of the lampshade support of FIG. 3;

FIG. 5 illustrates an exploded top plan view of the lampshade support of FIG. 3;

FIG. 6 illustrates a top plan view of the lampshade support of FIG. 3;

FIG. 7 illustrates a top plan view of a partial lamp assembly including the lampshade support of FIG. 3 with a lamp base of some embodiments;

FIG. 8 illustrates a front elevation view of a partial lamp assembly including the lampshade support of FIG. 3 and the lamp base of FIG. 7;

FIG. 9 illustrates a partial cutaway front elevation view of a lamp that includes the lampshade support of FIG. 3, the lamp base of FIG. 7, and the lampshade of FIG. 1;

FIG. 10 illustrates a top plan view of a partial lamp assembly including the lampshade support of FIG. 3 with an alternative lamp base of some embodiments;

FIG. 11 illustrates a front elevation view of a partial lamp assembly including the lampshade support of FIG. 3 and the alternative lamp base of FIG. 10;

FIG. 12 illustrates a partial cutaway front elevation view of a lamp that includes the lampshade support of FIG. 3, the alternative lamp base of FIG. 10, and the lampshade of FIG. 1;

FIG. 13 illustrates a top plan view of a ceramic lamp base according to an exemplary embodiment;

FIG. 14 illustrates a front elevation view of the ceramic lamp base of FIG. 13;

FIG. 15 illustrates a top plan view of a ceramic lampshade for use with the ceramic lamp base of FIG. 13;

FIG. 16 illustrates a front elevation view of a lamp that includes the ceramic lamp base of FIG. 13 and the ceramic lampshade of FIG. 15;

FIG. 17 illustrates a partial cutaway front elevation view of the lamp of FIG. 16;

FIG. 18 illustrates a front elevation view of a first alternative embodiment of the lamp of FIG. 9 or FIG. 12;

FIG. 19 illustrates a front elevation view of a second alternative embodiment of the lamp of FIG. 9 or FIG. 12;

FIG. 20 illustrates a front elevation view of a third alternative embodiment of the lamp of FIG. 9 or FIG. 12;

FIG. 21 illustrates a front elevation view of a first alternative embodiment of the lamp of FIG. 16;

FIG. 22 illustrates a front elevation view of a second alternative embodiment of the lamp of FIG. 16; and

FIG. 23 illustrates a front elevation view of a third alternative embodiment of the lamp of FIG. 16.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide lighting features that utilize ceramics.

A first exemplary embodiment provides a lamp comprising: a base; a lampshade support coupled to the base, the lampshade support comprising: a hub; and a set of spokes extending radially outward from the hub; and a ceramic lampshade.

A second exemplary embodiment provides a ceramic lamp comprising: a ceramic base; and a ceramic lampshade that rests on a top surface of the ceramic base.

A third exemplary embodiment provides a lamp comprising: a ceramic cylindrical base with an open top and a set of through holes along a circumference of the ceramic cylindrical base; a light source coupled to the ceramic cylindrical base such that light is able to pass through the set of through holes and through the open top; and a ceramic lampshade having an open bottom and a top hole through which light is able to pass.

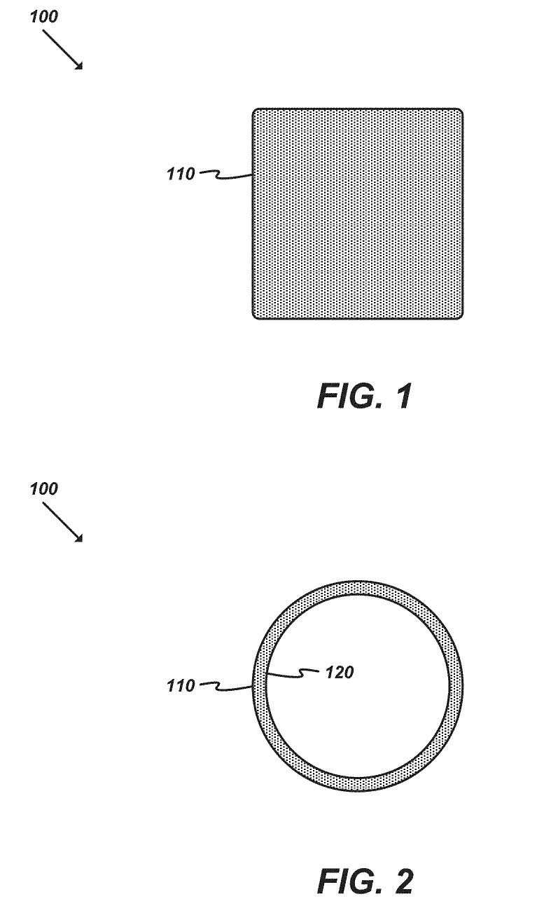

FIG. 1 illustrates a front elevation view of a ceramic lampshade 100 according to an exemplary embodiment. FIG. 2 illustrates a top plan view of the ceramic lampshade 100. As shown, the lampshade has an outer surface 110 and an inner surface 120.

In this example, the lampshade 100 is cylindrical, but different embodiments may include differently shaped lampshades. In some such embodiments, the shade may be about one half inch thick and may weigh about ten to fifteen pounds.

The inner surface 120 of the lampshade 100 may be coated with reflective and/or heat resistant material.

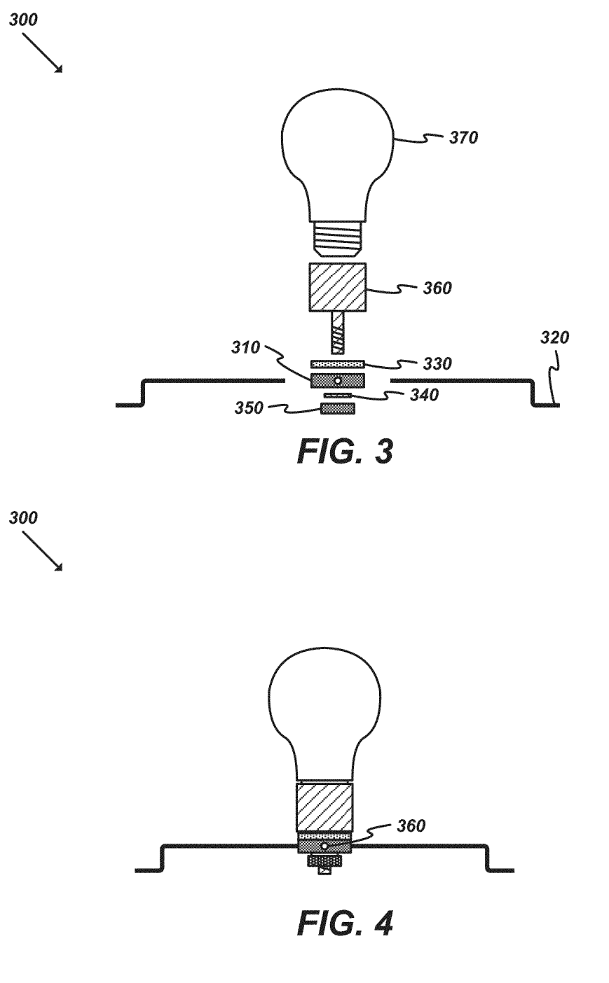

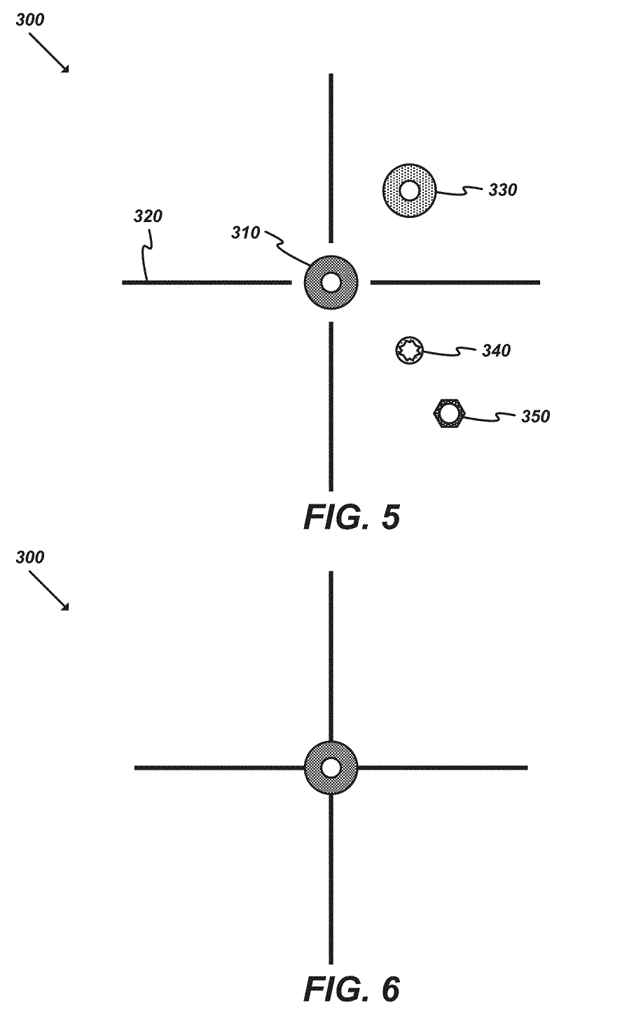

FIG. 3 illustrates an exploded front elevation view of a lampshade support 300 according to an exemplary embodiment. FIG. 4 illustrates a front elevation view of the lampshade support 300, as assembled. FIG. 5 illustrates an exploded top plan view of some elements of the lampshade support 300. FIG. 6 illustrates a top plan view of a portion of the lampshade support 300. FIG. 5 and FIG. 6 omit various elements for clarity (for instance, FIG. 6 includes only the hub 310 and spokes 320).

As shown, the support may include a hub 310, a set of spokes 320, one or more spacers 330, a lock washer 340, a nut 350, a socket 360, a bulb 370, and a set of spoke receptacles 380.

The hub 310 in this example is a disc-shaped element that includes a number of spoke receptacles 380. Each spoke receptacle may be able to retain a spoke 320 from the set of spokes. In some embodiments, the receptacles 380 may be threaded. Alternatively and/or conjunctively, spokes may be retained using adhesives, pins, screws, compression, and/or other appropriate ways. The hub 310 may include a through hole that is able to accept a protruding threaded member of the socket 360, as shown.

Each spoke 320 (or “radial member”, or “spider leg”) may be a cylindrically shaped piece of metal and/or other rigid material that includes multiple bends able to support a ceramic lampshade 100 of some embodiments. In this example, each spoke 320 includes two right-angle bends that support the lampshade 100 such that the lampshade is retained vertically and also horizontally.

Different embodiments may include differently shaped spokes 320 (e.g., straight spokes, spokes with bends less than or greater than right angles, spokes with more than two bends, curved spokes, etc.) Different embodiments may include different numbers of spokes (e.g., two, six, twelve, etc.). Such spokes may be arranged asymmetrically in some embodiments (e.g., some spokes may be closer together while other spokes are farther apart).

The number, shape, arrangement, and/or other spoke parameters may be at least partially based on a shape (and/or other attributes) of the lampshade to be supported (e.g., a cylindrical lampshade may be associated with any number of spokes greater than two, a triangular lampshade may be associated with three spokes, a hexagon may be associated with three, four, or six spokes, etc.).

The diameter or thickness of the spokes may be varied depending on the weight of the lampshade. In addition, the number of spokes (and thus the spacing between spokes) may be varied depending on the weight of the lampshade or other appropriate attributes. In this example, the spokes may have a diameter of about one quarter inch.

Each spacer 330 may be a disc shaped piece of metal, plastic, and/or other rigid or semi-rigid materials. In some embodiments, the spacer may be non-conductive.

The lock washer 340 and the nut 350 may be able to securely fasten the various elements of the support 300. Other embodiments may include other fastening elements, such as pins, compression fittings, adhesives, combinations of molded or machined components, etc.

The socket 360 may be any connector able to be coupled to a light emitting resource. In this example, the bulb 370 is a typical incandescent bulb type socket (i.e., the socket may include two electrical connectors and a threaded receptacle), but different embodiments may use different light sources and associated sockets 360. For instance, some embodiments may include light emitting diodes (LEDs) as the “bulb” 370. Such embodiments may include matching male and female connectors that allow a set of LEDs to be connected to the socket 360. As another example, a bulb 370 may have a compression fit connection within a socket 360.

The spoke receptacles 380 may be holes of a specified depth that are able to accept a portion of the spokes 320. In some embodiments, the receptacles 380 may be cylindrical, flat bottom holes. The holes may be partially threaded. Different embodiments may include differently shaped spokes 320 (e.g., square, oval, flat, etc.) that may be associated with various different receptacles 380. In some embodiments, each spoke 320 may include a protuberance of a particular shape that is different than the rest of the spoke, where the protuberance is able to couple with the receptacle 380. For instance, square spokes may have circular protuberances.

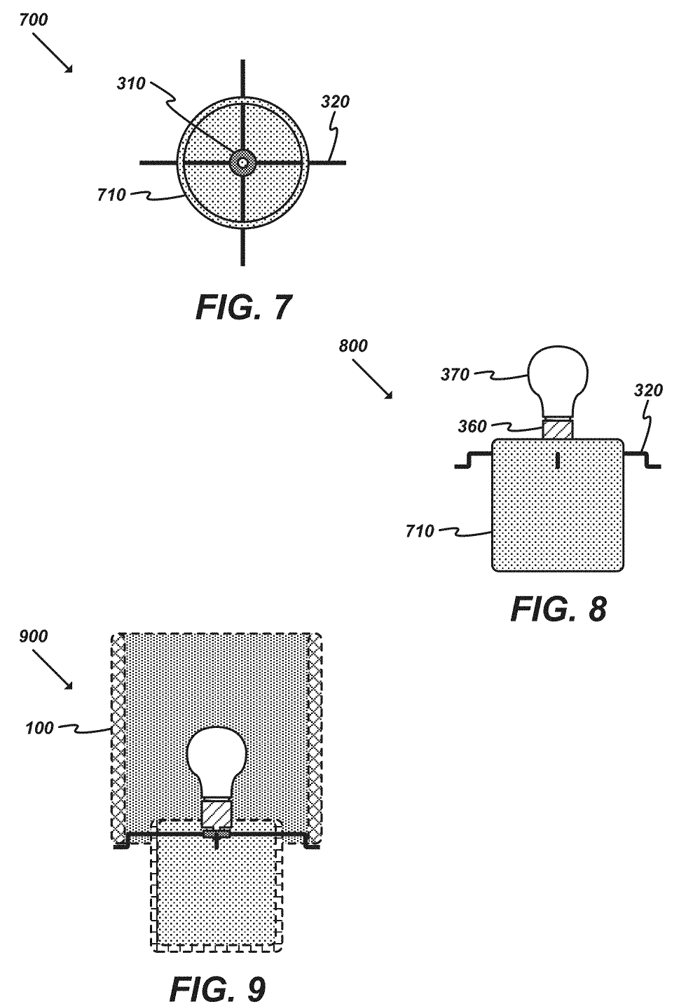

FIG. 7 illustrates a top plan view of a partial lamp assembly 700 including the lampshade support 300 with a lamp base 710 of some embodiments. FIG. 8 illustrates a front elevation view of a partial lamp assembly 800 including the lampshade support 300 and the lamp base 710. FIG. 9 illustrates a partial cutaway front elevation view of a lamp 900 that includes the lampshade support 300, the lamp base 710, and the lampshade 100.

In this example, the hub 310 is in the center of the base 710, but some embodiments may include an off-center hub, with spokes of different lengths, shapes, asymmetrical positions, etc.

The lamp base 710 in this example has a cylindrical shape that matches the shade 100. Different embodiments may have differently shaped lamp bases 710. For instance, some embodiments may include rectangular or square bases, elliptical bases, triangular bases, irregularly shaped bases, etc. The base may be made from various appropriate materials (e.g., metal such as brass, wood, ceramic, glass, etc.). The base in this example may be made of metal that is approximately one quarter inch thick.

In some embodiments, the base and the shade 100 may be opaque such that light is emitted only through the exposed top and bottom openings of the shade.

The lamp base 710 of this example includes through-holes able to receive a portion of the spokes as shown, such that the support 300 is held in place relative to the base 710. In some embodiments, the support 300 may rest on the top of the base 710 (which may include an indentation or other receptacle able to accept a spoke 320). In addition, different embodiments may locate the support 300 at different heights relative to the base 710, such that the light source 370 is more or less exposed relative to the top of the base 710.

In this example, the double-bend spokes 320 are able to retain the shade 100 both vertically and horizontally such that a specified relative position of the shade with respect to the base 710 and light source 370 is maintained.

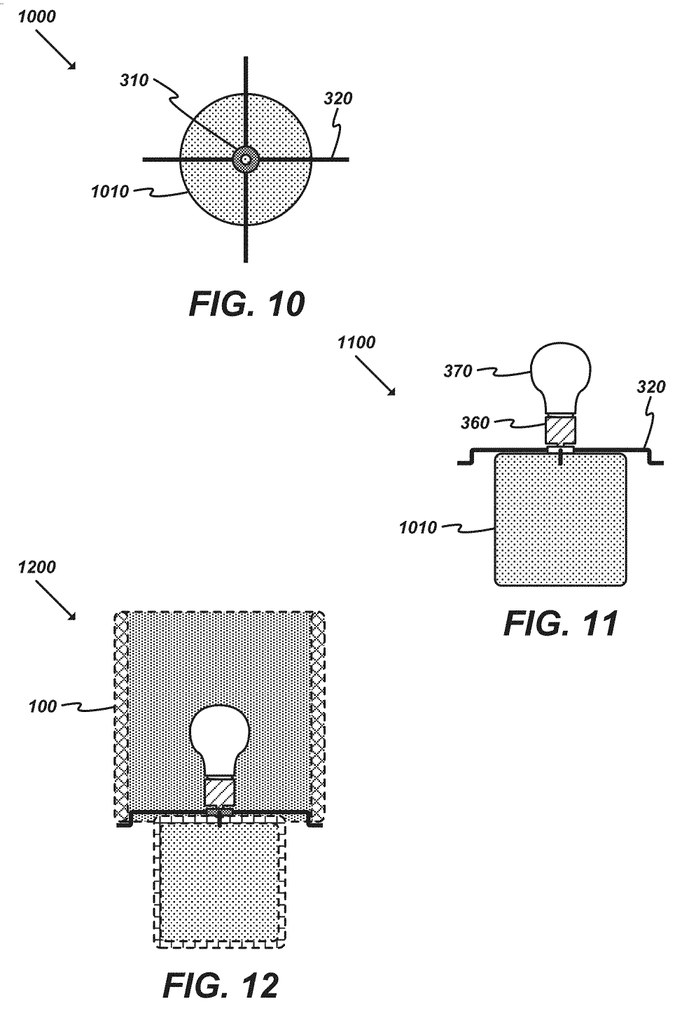

FIG. 10 illustrates a top plan view of a partial lamp assembly 1000 including the lampshade support 300 with an alternative lamp base 1010. FIG. 11 illustrates a front elevation view of a partial lamp assembly 1100 including the lampshade support of FIG. 3 and the alternative lamp base of FIG. 10. FIG. 12 illustrates a partial cutaway front elevation view of a lamp 1200 that includes the lampshade support 300, the alternative lamp base 1000, and the lampshade 100.

In this example, the support may rest on a top surface of the base 1010, as shown. The top surface may include a through-hole (in the center in this example) that is able to accept at least a portion of the socket 360. In addition, some embodiments may include recesses in the top surface of the base 1010 able to receive and retain the spokes 320. In this example, the base 1010 may be ceramic, however other appropriate materials may be used (e.g., metal, wood, plastic, etc.).

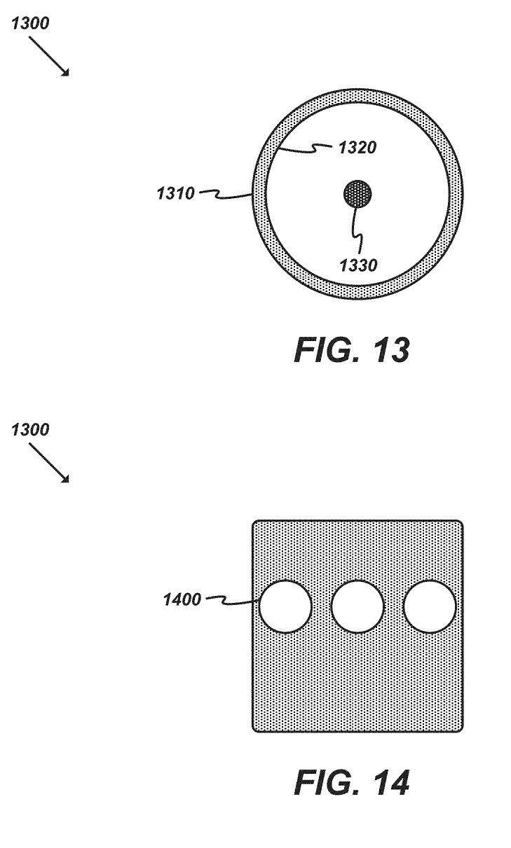

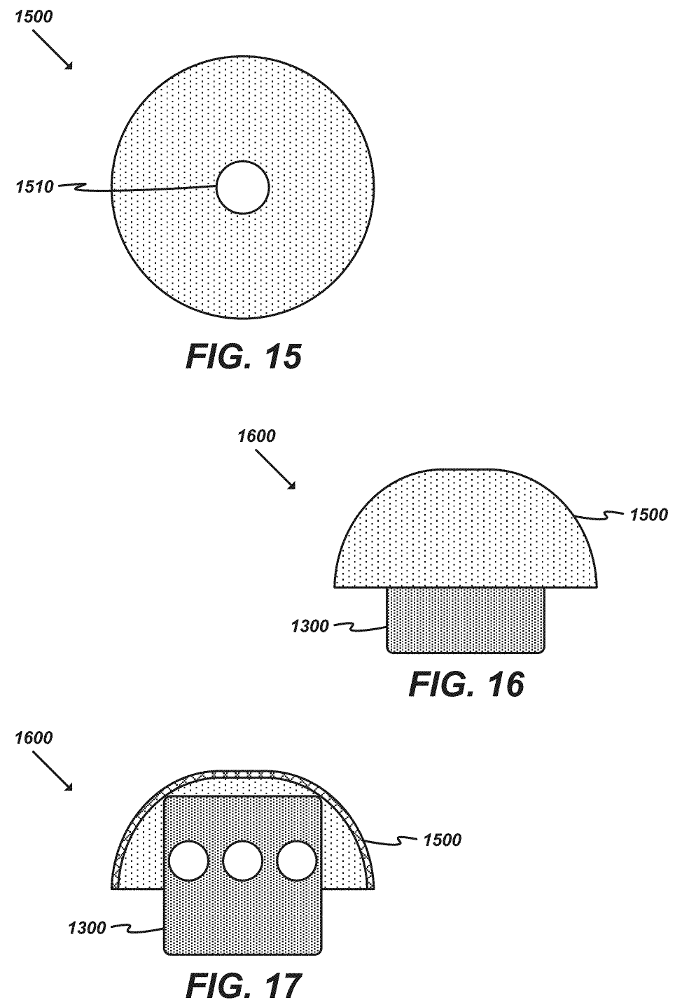

FIG. 13 illustrates a top plan view of a ceramic lamp base 1300 according to an exemplary embodiment. FIG. 14 illustrates a front elevation view of the ceramic lamp base 1300. FIG. 15 illustrates a top plan view of a ceramic lampshade for use with the ceramic lamp base 1300. FIG. 16 illustrates a front elevation view of a lamp 1600 that includes the ceramic lamp base 1300 and the ceramic lampshade 1500. FIG. 17 illustrates a partial cutaway front elevation view of the lamp 1600.

As shown, the base 1300 may be cylindrical, with an outer wall 1310 and an inner wall 1320. In addition, the lamp may include a light source 1330, associated couplings, and associated circuitry. In this example the source may include a socket coupled directly to the floor of the base 1300 (e.g., by including a through-hole in the base that is able to accept a threaded portion of the socket). In this example, there is no hub or spoke support for the light source (or the shade). The bulb or light emitting element of the source 1330 may be located such that it does not extend past the top of the base 1300.

The base 1300 may include a number of holes 1400 from the outer wall 1310 to the inner wall 1320. Such holes may allow light to pass through the otherwise opaque base 1300 (where light may be passed through the open top of the base as well). The base may typically be made from ceramic.

As the shade 1500 may be made from an opaque material (e.g., ceramic), the shade may include a top hole 1510 through which light may pass. In addition, light may be emitted through the holes 1400 and the open bottom of the shade 1500. In some embodiments, the inner surface of the shade may be covered with reflective material that may help disburse light from the light source.

The shade may include a lip or recess on an interior surface of the shade to match the top of the base 1300 when the shade is resting on the base. In some embodiments, a portion of the shade 1500 may be flat, for instance, in in the mushroom cap shape of lamp 1600. In some such embodiments, the flat area may be sized to match the base area such that the flat area of the shade 1500 rests on the top surface of the base 1300.

In this example, the shade 1500 may rest directly on the base 1300 as shown, eliminating the need for any other shade support or retaining element. In some embodiments, the lamp 1600 may include a shade support similar to support 300 described above. The support may be mounted within the base 1300 such that a light source coupled to the hub does not extend past the top of the base 1300.

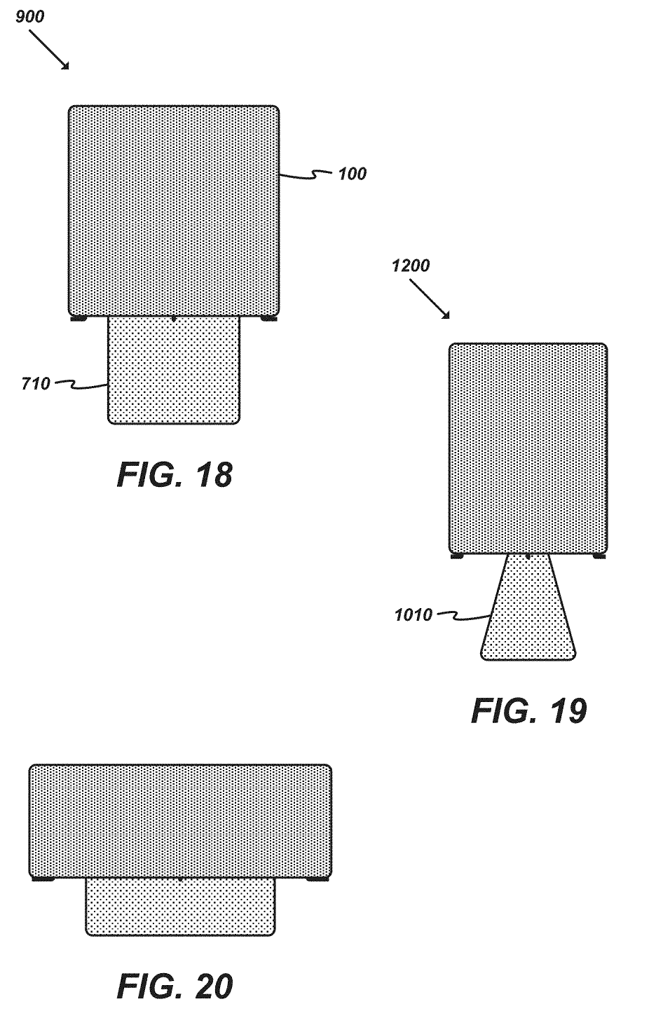

FIG. 18 illustrates a front elevation view of a first alternative embodiment of the lamp 900 or 1200. FIG. 19 illustrates a front elevation view of a second alternative embodiment of the lamp 900 or 1200. FIG. 20 illustrates a front elevation view of a third alternative embodiment of the lamp 900 or 1200. Each of these examples includes a cylindrical base 710 or tapered cylinder base 1010 and shade 100.

As shown, the relative heights, radii, and/or other attributes of the base 710 or 1010 and shade 100 may be varied. In addition, the base 710 or 1010 and/or shade 100 may be differently shaped (i.e., the base and shade may be rectangular, triangular, etc.) and/or may be differently shaped than each other (e.g., a square base may be combined with a cylindrical shade, a cylindrical base may be combined with a tapered shade, etc.).

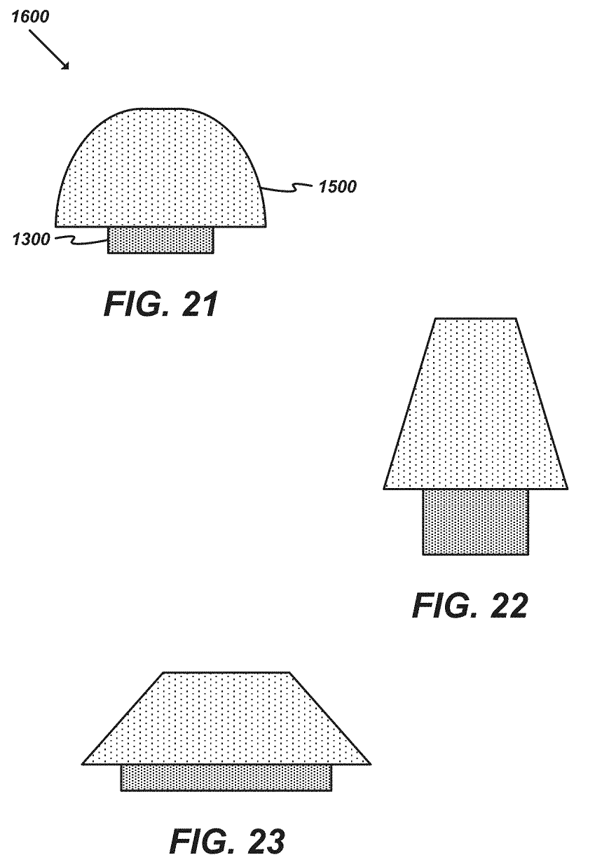

FIG. 21 illustrates a front elevation view of a first alternative embodiment of the lamp 1600. FIG. 22 illustrates a front elevation view of a second alternative embodiment of the lamp 1600. FIG. 23 illustrates a front elevation view of a third alternative embodiment of the lamp 1600. Each of these examples includes a cylindrical base 1300 and various differently shaped shades 1500 (mushroom cap and tapered cylinders of varying height and radius). As above, the base 1300 and shade 1500 may be differently shaped and/or differently shaped than each other.

One of ordinary skill in the art will recognize that various elements have been omitted for clarity. For instance, each lamp may include a power source such as a cord and plug that may be connected to a feature such as the socket 360. As another example, some embodiments may include an on/off switch, dimmer switch, etc. As still another example, some embodiments may include a battery or rechargeable battery. Such embodiments may include various appropriate connectors (e.g., universal serial bus connectors) that may allow charging power to be supplied to the lamp. Such elements may be located on the base of some embodiments.

In addition, although various differently shaped lamps were described above, various other embodiments could be differently shaped and/or otherwise differently arranged. Such arrangements may be at least partly based on a type of use of the lamp. For instance, a lamp may be intended for use as a wall sconce and include a base and shade that form semi-circles, with a flat side associated with the wall. Such embodiments may include a spoke and hub support, or may utilize a ceramic base and shade without other supports.

The foregoing relates to illustrative details of exemplary embodiments and modifications may be made without departing from the scope of the disclosure as defined by the following claims.

I claim:

1. A lamp comprising:
a base;
a lampshade support coupled to the base, the lampshade support comprising:
a hub; and
a set of spokes extending radially outward from the hub along a plane; and
a ceramic lampshade.

2. The lamp of claim 1, wherein the base comprises a set of through holes, each through hole able to accept a portion of a particular spoke from the set of spokes.

3. The lamp of claim 1, wherein the hub comprises a set of receptacles, each receptacle able to accept a portion of a particular spoke from the set of spokes.

4. The lamp of claim 1, wherein each spoke includes two right angle bends.

5. The lamp of claim 1, wherein the set of spokes comprises four spokes arranged at ninety degree intervals along a circumference of the hub.

6. The lamp of claim 1 further comprising a light source coupled to the hub.

7. The lamp of claim 1, wherein the ceramic lampshade is cylindrical.

8. A ceramic lamp comprising:
a ceramic base; and
a ceramic lampshade that rests on a top surface of the ceramic base.

9. The ceramic lamp of claim 8, wherein the ceramic base has a cylindrical shape and includes a set of through holes along a circumference of the cylindrical shape.

10. The ceramic lamp of claim 8 further comprising a light source coupled to an interior surface of the ceramic base.

11. The ceramic lamp of claim 8, wherein the ceramic base has a solid floor and an open top.

12. The ceramic lamp of claim 8, wherein the ceramic lampshade comprises a top opening and an open bottom.

13. The ceramic lamp of claim 8, wherein the ceramic lampshade has a mushroom cap shape.

14. The ceramic lamp of claim 8, wherein the ceramic lampshade has a tapered cylinder shape.

15. A lamp comprising:
a cylindrical base with an open top and a set of through holes along a circumference of the cylindrical base;
a light source coupled to the cylindrical base such that light is able to pass through the set of through holes and through the open top; and
a ceramic lampshade having an open bottom and a top hole through which light is able to pass.

16. The lamp of claim 15 further comprising a lampshade support coupled to the cylindrical base.

17. The lamp of claim 16, wherein the lampshade support comprises a hub and a set of spokes that extend radially outward from the hub.

18. The lamp of claim 17, wherein each spoke in the set of spokes comprises two ninety degree bends.

19. The lamp of claim 15, wherein an inner surface of the ceramic lampshade is reflective.

20. The lamp of claim 15, wherein the ceramic lampshade has one of a cylindrical shape, mushroom cap shape, and a tapered cylinder shape.
